(19) United States
(12) Patent Application Publication
(10) Pub. No.: US 2007/0089805 A1
(43) Pub. Date: Apr. 26, 2007

(54) Wood pelleter production system

(76) Inventors: Robert Henry Swaan, Quesnel (CA); Dewey James Swaan, Quesnel (CA); Donald Brock Martin, Quesnel (CA); Donald James Enns, Quesnel (CA); Harold C. Berkholtz, Williams Lake (CA)

Correspondence Address: Robert H. Swaan, 4252 Dog Prairie Road, Quesnel, BC, V2J 6K9, CA

(21) Appl. No.: 11/258,026

(22) Filed: Oct. 26, 2005

(51) Int. Cl. B27C 9/00

(52) U.S. Cl. 144/1.1

(57) ABSTRACT

A wood pelleter production system for wood chips and the like, having a wood chip infeed deck with integrated dryer deck with an array of inverted louvers that allow air or heated air and flue gas mix to flow up through the chip flow. The chips flow from the infeed dryer deck to a hammer mill to refine the wood chips, the wood chips are transferred within a re-circulatory airflow system, to a refined wood chip dispenser, for consistent delivery and monitoring of the refined wood chips to a chip pelleter. Below the pelleter is a pellet cooling means that cools the pellets as the pellets collect and are drop through a cycling grate onto a pellet transfer means with airflow screens for separating wood fines into a re-circulation airflow system which includes a means for separation of wood particles, wood fines and dust from being released into the atmosphere.

### FIELD

The present invention relates to a wood pelleter system used to produce pellets for use in wood fired pellet stoves and the like. More specifically, the present invention is a wood pelleter system with a dynamic wood chip infeed and drying system, a re-circulating airflow system, improved consistency of delivery of wood chips to the pelleter, and a simplified pellet cooling method and with separation and re-circulation means of fines.

### BACKGROUND OF THE INVENTION

Various types of pellet mills and system are already known. Some are listed as follows;

Inventors are aware of U.S. Pat. No. 6,163,981 issued to Nilsson Dec. 26, 2000, entitled “Method and Apparatus for Drying Wood Particles”. Inventors are also aware of U.S. Pat. No. 5,815,941 issued to Wenger, et al. on Oct. 6, 1998, entitled “Pellet Cooler Having Dual Grate Pellet Outlet”. Inventors are also aware of U.S. Pat. No. 5,549,057 entitled “Combustible Pellet Dryer” issued to Favreau on Aug. 27, 1997. Inventors are also aware of U.S. Pat. No. 4,529,407 issued to Johnston, et al. Jul. 16, 1985 entitled “Fuel Pellets”. Inventors are also aware of U.S. Pat. No. 4,451,231 entitled “Dryer of Particulate Material” issued to Murray on May 29, 1984. As well, Inventors are aware of U.S. Pat. No. 4,324,561 issued to Dean, et al. Apr. 13, 1982, entitled “Combustible Fuel Pellets Formed From Botanical Material”.

The above patents, although useful in their specific areas, do not cover the specific application and process of the present invention. As well, few if any of the previous known devices approach the intricacy of the present invention for producing wood pellets for fuel, and do not teach similar process for wood fuel pellet production.

### SUMMARY OF THE INVENTION

It is therefore an object of the present invention to produce a wood pelleter system that substantially dries the wood chips as they are delivered into the pelleter system.

Another object of the present invention to provide a specially designed pellet burner to provide spark free flue gas mixed with air to the dryer deck to efficiently dry the wood chips on the dryer infeed deck.

Another object of the present invention to consistently deliver the wood chips more evenly to the pelleter for a more consistent size and density of the pellet.

It is also an object of the present invention to efficiently cool the pellets as they are ejected from the pelleter.

It is yet another object of the present invention to re-circulate wood particles, fines and airflow, and to prevent particles from entering the environment, both inside the pelleter system building and outside the building.

Mechanical System

The invention comprises a sizable building, basically divided into two areas; the wood chip delivery and containment area or “chip barn” on one side, with a solid wall dividing the two areas, where the mill housing area is directly on the other side of the wall at a slightly lower height. The system begins with the wood chips being delivered or dumped directly onto the floor of the chip barn, starting at the dividing wall and piling up, tapering down towards the delivery area. The chips are also pushed up towards the dividing wall, where there is a chain driven section in the floor at the far end of the wood chip delivery area, called the “infeed dryer deck”.

The infeed dryer deck consists of a pair of ten-foot wide variable speed “bar chains” running directly adjacent and parallel of the other. The evenly spaced bars, or rectangle tubing, mounted to the sides of the endless chains, draw the chips from the bottom of the chip mound, pulling out a substantial amount of chips in front of and along with each bar of the pair of endless chains. The chain driven bars move on top of metal sheeting, referred to as the “deck”, which extends well into the chip delivery area and also into the mill housing area. The bar chains return in a cavity under the metal deck which is suspended on the sides and supported in the center between the bar chain pairs.

There is a rigid “shear gate”, which spans above the infeed dryer deck, where the gate is hydraulically adjustable in height, to shear off the desired height of chips being drawn from under the wood chip mound. By adjusting the speed of the bar chains, as well as adjusting the shear gate height, the infeed dryer deck can continually and dynamically meter the chip delivery, as may be desired by mill production parameters, which will include lowering the moisture content of the wood chips.

Air is heated in a specially designed pellet burner, which is located outside of the mill housing area. Directly above the pellet burner is a “mixing chamber”, where there are adjustable doors at various levels that allows air in and mixes the air with the flue gas from the burner. The chamber has shelves where the flue gas and air mix can swirl up and travel through the shelves. As well, the mixing chamber area provides a region where sparks from the pellet burner can burn out. Once mixed with air the flue gas and heated air is blown, via a large variable frequency controlled blower, horizontally along a large duct, through a spark detector and diverter, which will divert the heated mixed air and flue gas to the atmosphere if a spark is detected. The heated mixed air and flue gas is then ducted down into the mill housing area and into a plenum underneath the dryer deck and through a louvered section across the width of the infeed dryer deck, causing the heated air and spark free flue gas to move up through the wood chips, thereby efficient drying the wood chips on the dryer infeed deck as may be required.

The louvers are shaped so that the incoming wood chips pass over top of the louvers without being pushed down into the louvers, but allowing heated air and flue gas to flow through the wood chips as they are being drawn over these louvers. Therefore the infeed dryer deck; meters, dries and delivers the wood chips.

The dried wood chips then spill off of the infeed dryer deck and onto a vibratory conveyor mounted on the floor of the mill housing area. The vibratory conveyor delivers the chips from the infeed deck to a double 9″ auger that raises the chips up to the top of a nearby rotary hammer mill, also mounted on the floor of the mill housing area. At the point where the vibratory conveyor delivers the wood chips to the double 9″ auger, there is a debris separator, where there are magnets placed to pick up any iron or steel hidden in the wood chips, as well as a screen on top of the vibratory conveyor, with specific sized openings to remove anything larger than that of the desired size of wood chip.

The double 9″ auger raises the wood chips up and drops them into the rotary hammer mill, where the hammer mill refines the chips to the desired size and consistency for pelleting. The hammer mill, which produces an airflow of it's own, is supplied with additional airflow via a high volume auxiliary fan. The combined airflow, carries the refined chips up to the top of the system within a large diameter pipe, to a height well above the mill housing area, and delivers the refined wood chips into the top of a large cylindrical “cyclone”. Within the cyclone the inflowing air causes a swirl, which forces the chips out to the side of the cylinder where the chips then drop down to the bottom of the cyclone by gravitational forces, where the chips collect for metered delivery via a rotary metering valve.

The airflow leaves the upper side of the cyclone and is returned to the hammer mill infeed, where the airflow is continuously recycled within a substantially closed-loop re-circulatory airflow system. As will be mentioned below, the airflow is also piped off for use in other sections of the pelleter mill and is used to reduce small particles entering the environment and to remove fines from the pellets as well as cooling the pellets after the pelleter.

The rotary metering valve at the bottom of the cyclone meters and delivers the refined chips to a horizontal auger transport trough, which delivers the chips via adjustable gates to hoppers above and offset of the pelleter(s) below. From this point the system is designed in a modular form where additional hoppers, pelleters and cooling bins can be added to the system as production output demand increases.

The auger trough gate delivers wood chips to a substantially wide hopper with a length of approximately the same as the width. Within the bottom of the hopper, there are four counter rotating horizontal augers running the length of the bottom area of the hopper.

Each auger is set in a trough, and each trough is adjoining the adjacent trough. These adjoining troughs come to a sharp pointed edge atop and along the length of each trough within the bottom area of the hopper. These sharp pointed lineal edges are designed to eliminate bridging or cavitations of the wood chips above the augers. The counter rotation of each auger within the each trough also counteracts the tendency of the chips to bridge and cavitate.

The augers and troughs continue out past the hoppers bottom edge a small amount, where the chips are therefore controllably released into a consistent and even freefall, for a relatively short drop into a tapered infeed atop the pelleter(s). There is a glazed viewing window on the side of the hopper as well as a glazed viewing window over the last auger section outside of the hopper. These viewing windows allow the rate of delivery as well as the consistency of delivery to be visual monitored as may be required for fine-tuning of the chip infeed to the pelleter(s). The pelleters are a rotational die type commonly used in various palletizing industries, but are fitter with specially designed dies, each designed to suit the wood species being processed for desired size and density.

The pellets fall from beneath the pelleter into a hopper or “cooling bin”, where the pellets fall through a chute and into the cooling bin and collect to a certain height. On the bottom of the cooling bin there is a substantially wide and long hydraulically controlled grate. When the pellets in the cooling bin reach the desired height, the grate, made up of a plurality of elongated bars are rotated to dump the pellets onto a vibratory conveyor directly below.

The desired height of pellets dumped onto the vibratory conveyor is only about an inch or so. The cooling bin is enclosed and connected to the re-circulating airflow system. The pellets then drop out of the cooling bin through a progressively narrowing chute, so as to deliver the pellets onto the vibratory conveyor mounted on the pellet mill floor below. The cooling bin grates close and cycle open as the pelleter delivers more pellets to the cooling bin, for delivery of another layer of pellets to the vibratory conveyor. The cooling bin grates allow a certain amount of airflow through the pellet layer when closed, this combined with the rush of air through the grates and into the cooler bin as the grates are opened, effectively cools the pellets as they are delivered to the vibratory conveyor below.

The pellets move along the floor mounted vibratory conveyor, and over a plurality of screened sections that are set flush to the vibratory conveyor bottom. Below these screened sections there is an enclosure, or plenum that is piped to the re-circulatory airflow system. The screen is of such a size that the pellets are transported over the screen and only fine wood particles, or so named “fines”, that are moving along with the pellets, are sucked through the screens and into the re-circulatory airflow system. The vibratory conveyor then feeds directly onto a substantially long out-feed belt conveyor and out to a bucket elevator, where the bucket elevator raises the pellets up for distribution to the outside storage bins, or to be bagged, or for loading directly onto train cars or trucks for bulk delivery.

The re-circulatory airflow system includes an air bagged cyclone, or “bag house” which is adjoining the entire airflow system via a large diameter pipe as well as a re-circulatory pickup pipe near the bottom of the bag house. The bag house is preferably mounted outside of the mill area, where the air can be cleaned and released to the outside atmosphere without retaining any dust or fines. This is particularly desirable within a town site or within a populated area.

Control System

The invention has an intricate control system that includes a control room where a computer system is situated. The computer system is connected to a network and can be monitored and adjusted from any remote location if required. The control room is situated near the center of the mill area, from the control room personal can adjust speeds of electric motors throughout the mill as may be required and monitor amperage draw for each of the main machine modules within the system. There are a few computers in the system all of which have a graphical user interface or GUI″, where the GUI shows all the systems machines, their various sensor readings and any alarms that can be tripped within the system. As will be explained in more detail below, the various sensors throughout the system, along with periodically physical moisture testing of both the wood chips as they move past the infeed dryer deck and the pellets after they have been milled, give the operator the necessary information to be able to adjust the system in various manners so as to maintain the highest production rate desired within the constraints of the present wood chip species and qualities. Of course the operator can shut down any part of, or the whole system remotely or locally, as might be required for periodic maintenance or repair.

Most of the motors in the system include amperage sensors and speed controls, which allows the operator to measure present amperage and review past amperage, and adjust the machines from anywhere between 0 and 100% in 1% increments. The electric motor(s) driving the pelleter(s) includes a field temperature sensor where it has been found that the motor(s) can be run at a higher production rate, i.e. increase tons per hour by monitoring the field temperature to maximize amperage efficiency.

The shear gate height is hydraulically adjustable only as may be needed if there are special chip conditions, and so the height setting of the incoming chips is only periodically, either remotely using the GUI or locally.

As required to lower moisture content in the wood chips, a heated air and flue gas mix flows from the mixing chamber above the pellet burner located outside the mill housing area along a large duct, through an automatically operated spark detector and flue gas and air diverter, then down into the mill housing area and into the plenum ducted to the infeed deck. The CFM of the heated air and flue gas mix is adjusted from the GUI. The heated air and flue gas mix is collected above the infeed deck via a housing or plenum above the dryer deck and then plumbed into the re-circulatory air duct that is sent to the bag house. The infeed deck speed as indicated by its amperage draw, and is adjusted as required from the GUI. The vibratory conveyor can handle narrow or wide flows of wood chips, so it maintains a constant speed and delivers the dried chips to the hammer mill auger. The vibratory conveyor can be shut off or started by the GUI. The hammer mill auger can be adjusted by the GUI so as to raise more or less chips up to feed the hammer mill.

The hammer mill speed as indicated by its amperage draw, is adjusted as required from the GUI. The auxiliary fan speed as indicated by its amperage draw, is adjusted as required from the GUI to increase or decrease air volume in the re-circulatory air system.

The cyclone atop the building has a sensor on the side that warns via the GUI when the chip level within is too high. The rotary metering valve below the cyclone, speed is adjusted as required to feed the horizontal auger below from the GUI. If the re-circulatory airflow pressure in the cyclone drops the auxiliary fan can be adjusted by the GUI.

The horizontal auger transport trough speed as indicated by its amperage draw, is adjusted as required from the GUI. There is a slide gate that feeds the pelleter(s) hopper below, the slide gate is adjusted if required so as to distribute the chip flow in horizontal the auger to the next pelleter module as may be required. The pelleter infeed hopper is monitored periodically by viewing means and the slide gate or the counter rotating horizontal augers in the bottom of the bin speed can be adjusted as required, from the GUI.

The pelleter(s) speed as indicated by its amperage draw, is adjusted as required from the GUI. There is also a temperature sensor showing the pelleter operating temperature on the GUI. There is an access door for manually scooping pellets after the pelleter, for physically monitoring of the pellet density and moisture content.

The cooling bin bellow has a temperature sensor and a pellet height sensor monitored from the GUI. The cooling bin automatically releases the pellets through the hydraulically controlled grate as soon as the pellets reach the desired height in the cooling bin.

The vibratory conveyor directly below the cooling bin runs automatically at a constant speed and can be monitored, and turned on and shut off from the GUI as required.

The out-feed belt conveyor speed and can be monitored, and turned on and shut off from the GUI as required.

The bag house has a height sensor monitored by the system and will produce an alert if this height is reached. The bag house also has a rotary metering valve that can be adjusted and turned on and shut off from the GUI.

### BRIEF DESCRIPTION OF THE DRAWINGS

Advantages of the present invention will become more fully appreciated as the same becomes better understood when considered in conjunction with the following detailed description of an illustrative embodiment and accompanying drawings, in which like reference characters designate the same or similar parts throughout the several views, and wherein;

FIG. 1 is a plan view of the invention showing the pelleter system overview.

FIG. 2 is a side elevation view of the invention showing sectional view “A” taken from FIG. 1 of the infeed dryer deck.

FIG. 3a is a plan view of the invention showing the pelleter infeed module.

FIG. 3b is a side elevation view of the invention showing sectional view “B” taken from FIG. 3a of the pelleter infeed module.

FIG. 4a is a plan view of the invention showing the pelleter outfeed chute with cooler bin module and vibratory conveyor below.

FIG. 4b is a sectional elevation view of the invention showing sectional view “C” taken from FIG. 4a showing the cooler bin grate and vibratory conveyor below.

FIG. 4c is a partial sectional elevation view of the invention showing sectional view “D” taken from FIG. 4a showing the cooler bin grate in the closed position.

FIG. 4d is a partial sectional elevation view of the invention showing sectional view “D” taken from FIG. 4a showing the cooler bin grate in the open position.

FIG. 5a is a plan view of the invention showing the vibratory conveyor with screened sections and the outfeed belt conveyor.

FIG. 5b is a sectional elevation view of the invention showing sectional view “E” taken from FIG. 5a showing the screened bottom of the vibratory conveyor and airflow plenum.

FIG. 6 is a partial plan view of the invention taken from FIG. 1 showing pellet burner outside of the mill housing area.

FIG. 7a is an partial elevation view of the invention showing the pellet burner.

FIG. 7b a sectional elevation view of the invention showing sectional view “F” taken from FIG. 7a showing inside the pellet burner.

FIG. 8 is a schematic, or flow diagram of the invention showing the complete pelleter system, where solid arrows designate the flow of wood chips, wood pellets and wood fines and dashed arrows designate airflow.

### DETAILED DESCRIPTION OF THE PREFERRED EMBODIMENTS

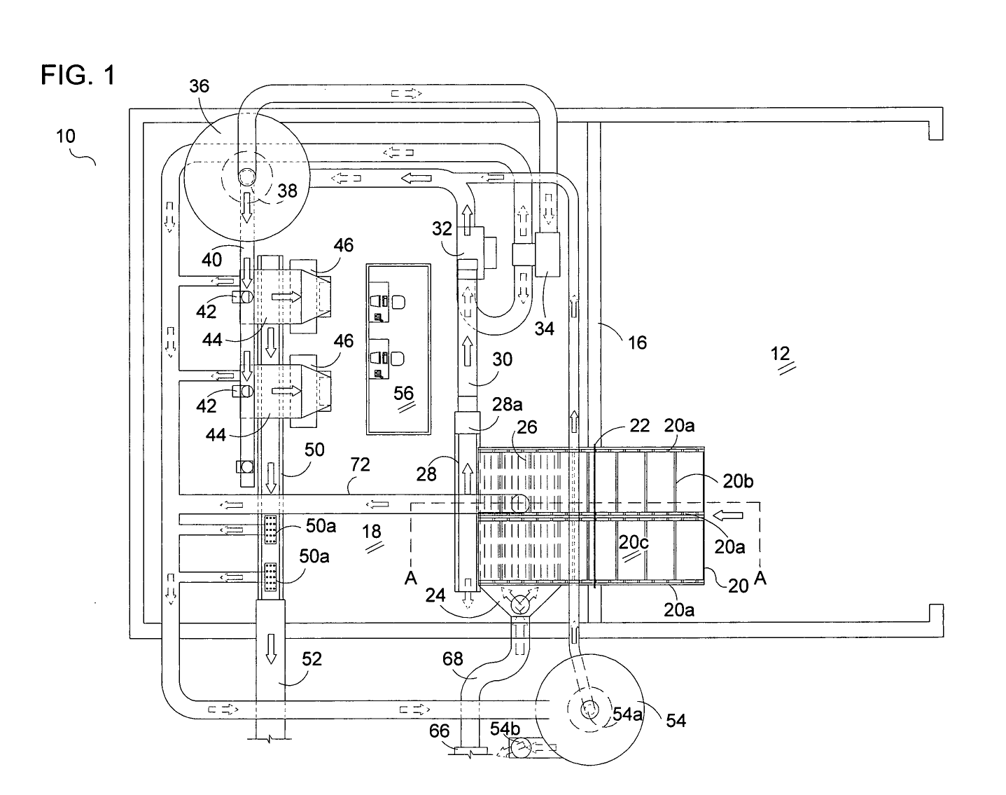

The wood pelleter production system is generally referred to as 10. Solid arrows designate chip and pellet flow and dashed arrows designates airflow. As seen in FIG. 1 shown in plan view, where 12 is the chip barn, 14 is the dividing wall and 18 is the mill housing area. Infeed dryer deck 20, with endless chains 20a and chain driven bars 20b. The chain driven bars 20b move on top of metal deck 20c. A shear gate 22, spans above and across the infeed dryer deck 20.

A heated air and flue gas mix flows from wood pellet burner 23 outside the mill housing area 18 and into the mill housing area 18 and into plenum 24 under infeed dryer deck 20. The heated air and flue gas mix flows up through a louvered section 26 spanning the width of the infeed dryer metal deck 20c, within the mill housing area 18. Vibratory conveyor 28 is mounted on the floor of the mill housing area 18, at the end of infeed dryer deck 20. The vibratory conveyor 28 has a debris separator 28a. The vibratory conveyor 28 flows into auger 30, which in turn flows into rotary hammer mill 32. An auxiliary air fan 34, combines airflow with hammer mill 32.

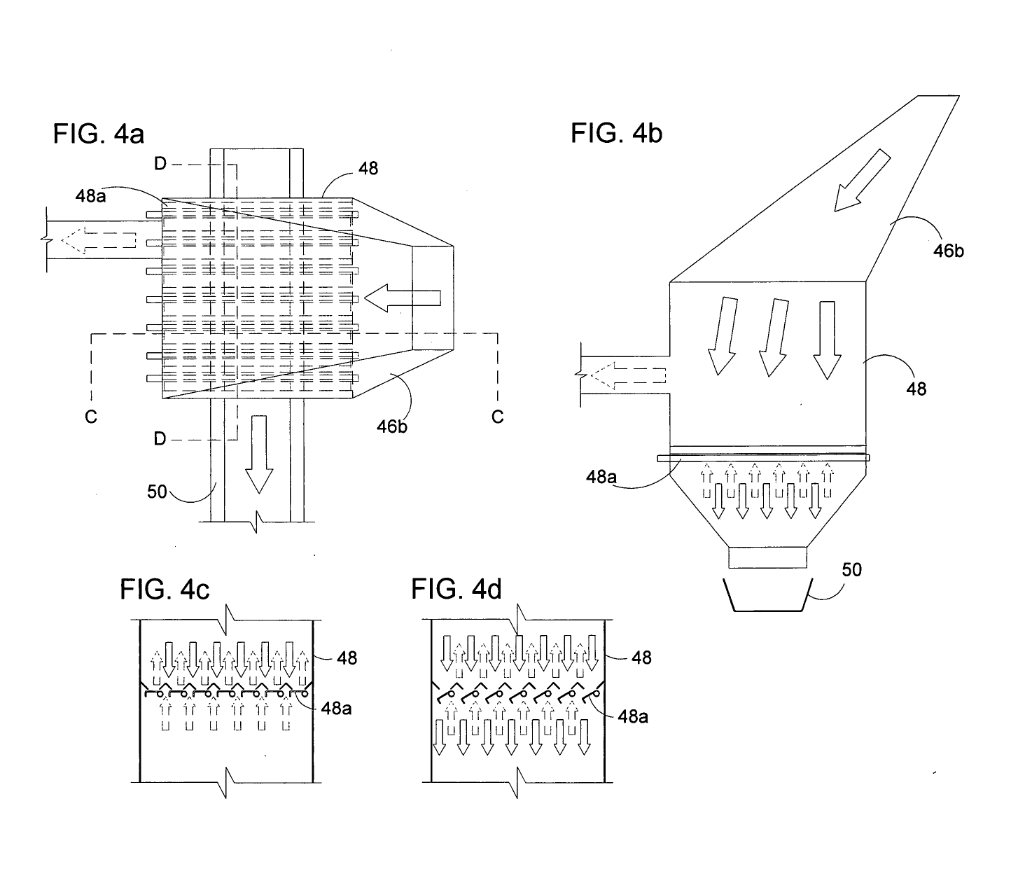

From hammer mill 32 refined chips are sent to the top of the system to the cyclone 36. The chips then drop down to the bottom of cyclone 36, where the chips are metered via a rotary metering valve 38. Rotary metering valve 38 delivers the refined chips to horizontal auger 40, where horizontal auger 40 delivers the chips through adjustable gates 42 to pelleter infeed hoppers 44, where infeed hoppers 44 feed pelleters 46.

Where pelleters 46 drop the pellets to cooler bins 48 (see FIG. 4) where cooler bins 48 in-turn drop the pellets onto vibratory conveyor 50. Vibratory conveyor 50 delivers pellets to the outfeed belt conveyor 52. The bottom of vibratory conveyor 50 has screened sections 50a where screen sections 50a are plumbed into the re-circulatory airflow system from beneath vibratory conveyor 50, to bag house 54. Bag house 54 is also adjoining the airflow system via a re-circulatory pickup 54a at the bottom center of the bag house 54. Bag house 54 has an atmospheric vent 54b.

Also shown in FIG. 1 in mill housing area 18, is control room 56.

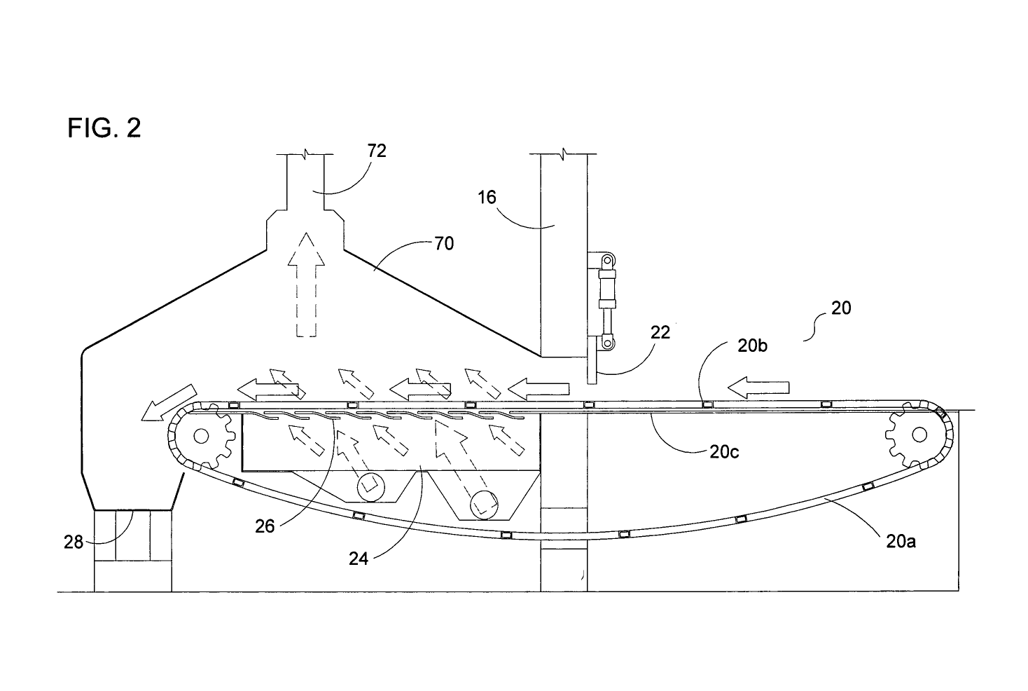

As seen in FIG. 2 shown in sectional elevation view “A” from FIG. 1, infeed dryer deck 20 includes steel deck 20c, where steel deck 20c includes inverted louvers 26. Air or heated air is blown into plenum 24 and rises through louvers 26, as wood chips pass on top of steel deck 20c.

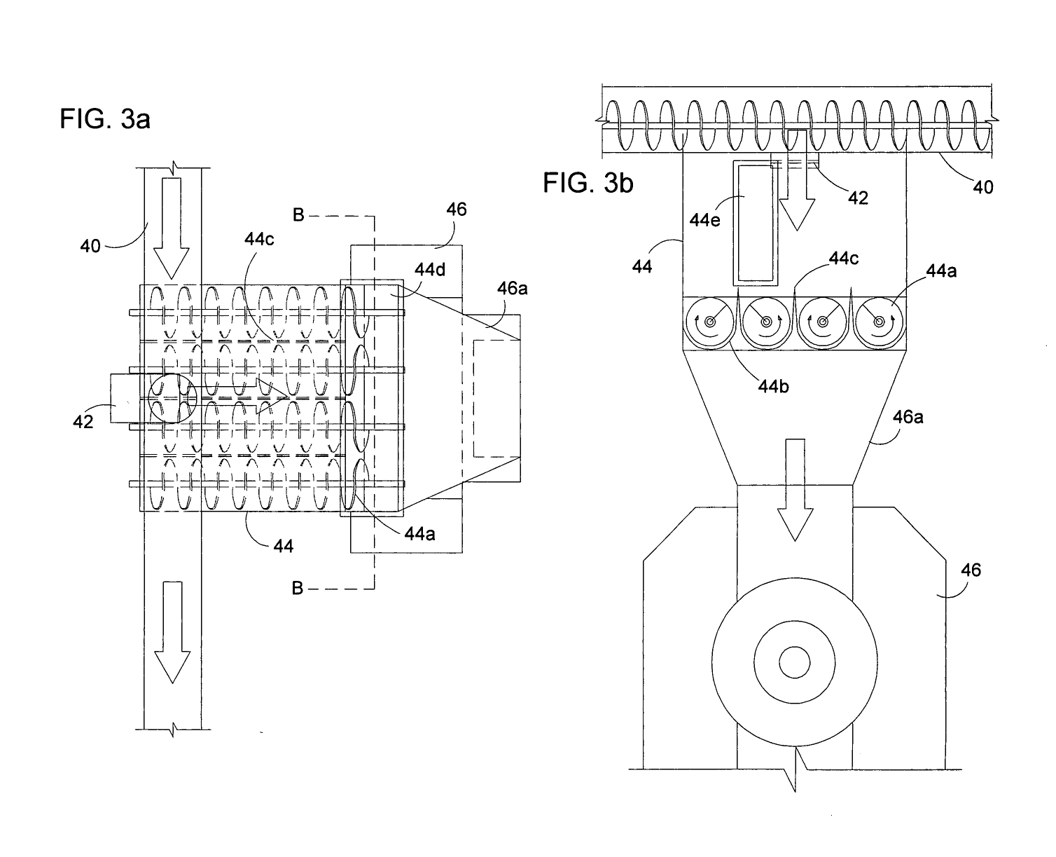

As seen in FIG. 3a and FIG. 3b, sectional view “B” from FIG. 3a, auger trough 40 via gate 42 delivers wood chips to hopper 40. Within the bottom of hopper 44, there are four counter-rotating horizontal augers 44a. Adjoining troughs 44b, come to a sharp pointed edge 44c. There is a glazed viewing window 44d across the ends of augers 44a. As well there is a glazed viewing window 44e on the front side of hopper 44.

As seen in FIG. 4a, pelleters 46 drop the pellets into cooler bins 48, where pellets fall through pelleter chutes 46a and as seen in FIG. 4b a sectional view “C” from FIG. 4a, fall onto rotationally operated grate 48a. Where air passes up through grate 48a and into the re-circulatory airflow system. As better seen in FIG. 4c a sectional view “D” from FIG. 4a. And as seen in FIG. 4d sectional view “D” from FIG. 4a, more air volume is allowed to pass through grates 48a as grates 48a are rotated to dump the pellets onto vibratory conveyor 50 below.

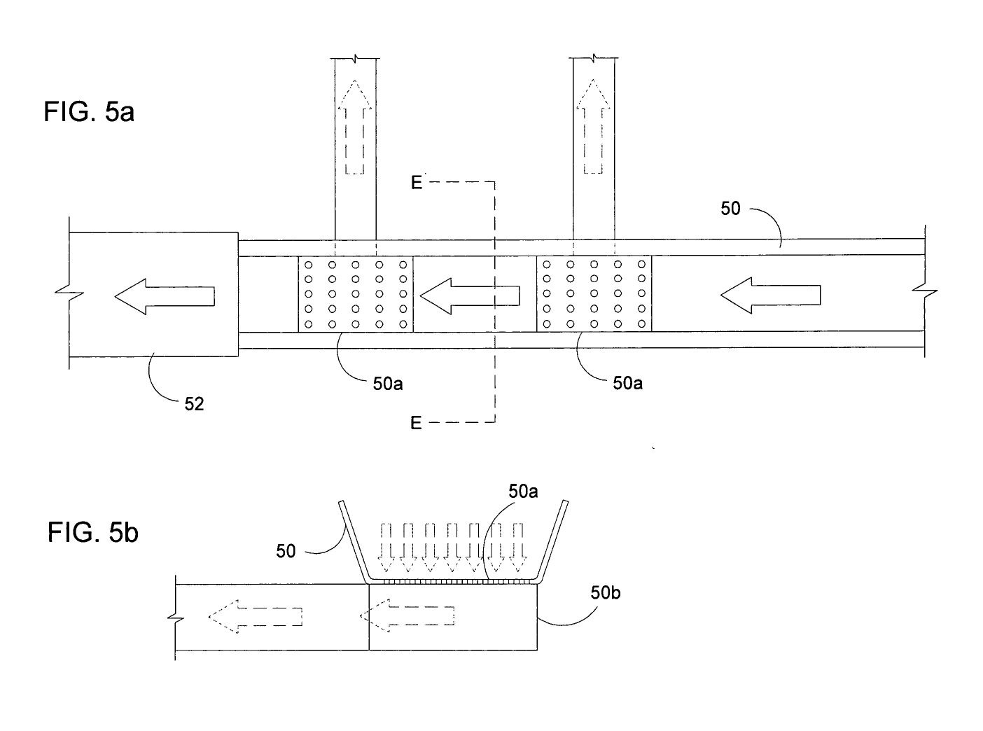

As seen in FIG. 5a the pellets move along vibratory conveyor 50 and over a plurality of screened sections 50a in the bottom of vibratory conveyor 50. As better seen in FIG. 5b, sectional view “D” below screened sections 50a there is a plenum 50b that draws air and fines to the re-circulatory airflow system.

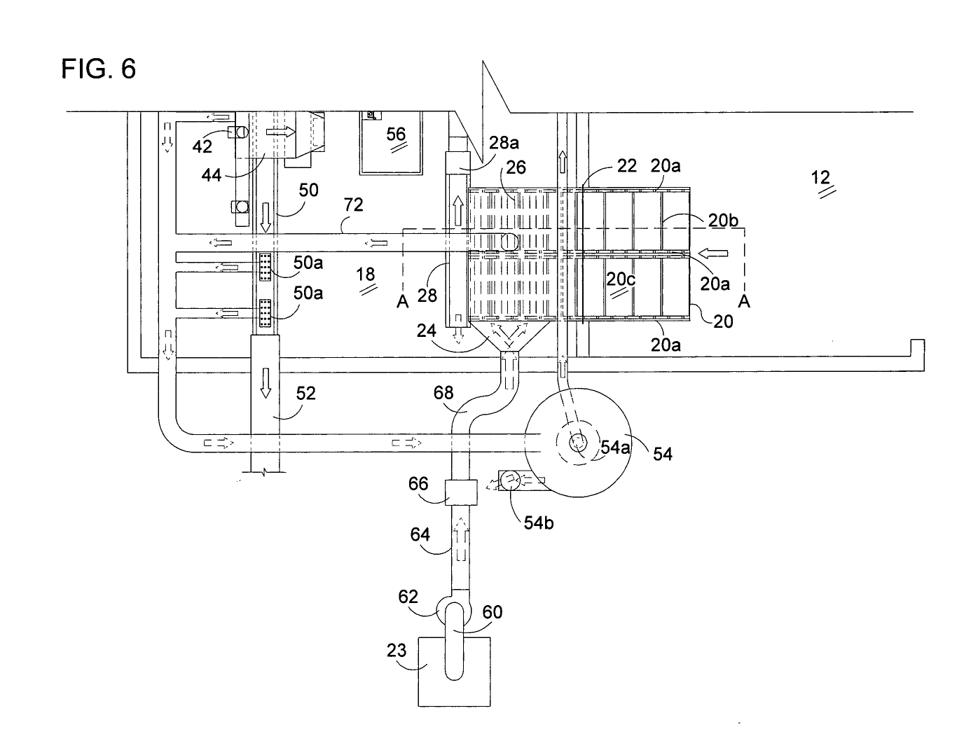

As best seen in FIG. 6, pellet burner 23 is located outside the mill housing area 18 and provides a heated air and flue gas mix that flows from pellet burner 23 through duct 60 by blower 62. The heated air and flue gas mix is blown through duct 64 into spark detector and diverter 66. The heated mixed air and flue gas is then ducted into the mill housing area through duct 68 and into plenum 24 underneath dryer deck 20. The heated mixed air and flue gas rise through louvered section 20a and are collected above the infeed deck 20 in plenum 70. Heated air and flue gas mix is then plumbed into the re-circulatory air duct through duct 72, which is routed to bag house 54.

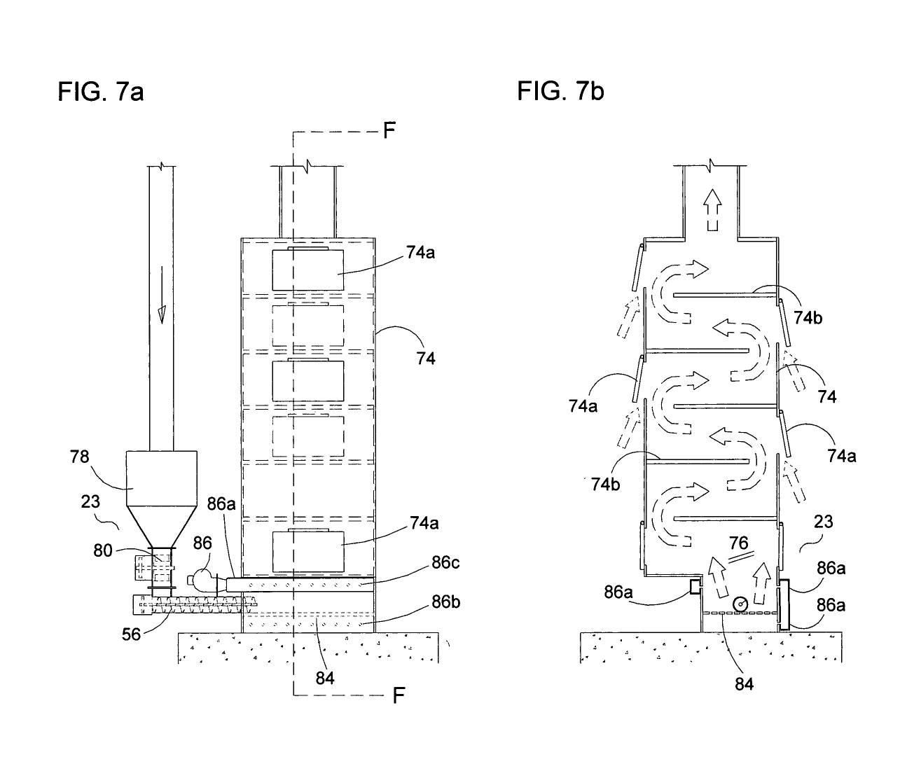

As best seen in FIG. 7a and 7b, pellet burner 23 includes a mixing chamber 74 which is directly above pellet burner 23, where mixing chamber 74 has adjustable doors 74a at various levels adjacent shelves 74b, where atmospheric air enters into mixing chamber doors 74a and mixes with flue gas from the burner combustion area 76.

Pellets are delivered to pellet burner 23 through hopper 78 and in turn through rotary valve 80 and down into auger 82 for horizontal delivery to burner grate 84. Combustion blower 86 delivers combustion air through manifold 86a, with primary combustion air rising up through burner grate 84 through holes 86b and secondary combustion air is delivered to combustion area 76 through holes 86c in lower walls of pellet burner 23.

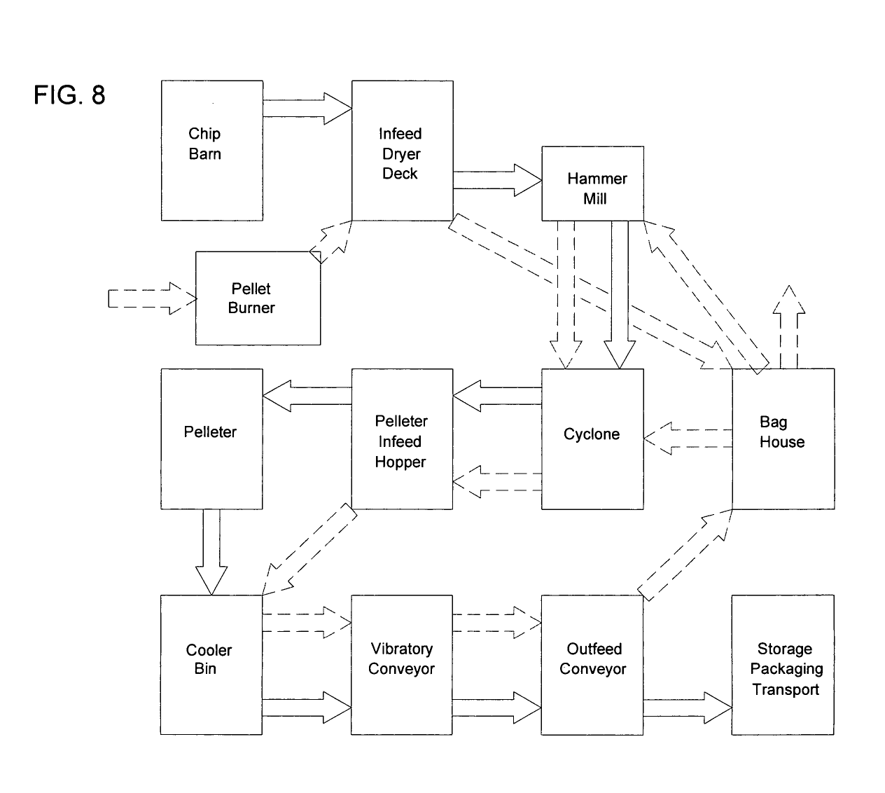

FIG. 8 shows a flow diagram, where solid arrows designate the flow of wood chips, pellets and fines and dashed arrows designates airflow.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. These modifications may include the production of pellets from organic fibre other than from wood chips, which may include bark, straw or other organic fibre.

It is intended that the scope of the invention be defined by the Claims appended hereto and their equivalents.

What is claimed is:

1. A wood pelleter production system, comprising:
a) a wood chip receiving area;
b) a wood chip infeed dryer deck;
c) means to refine said wood chips;
d) a combined airflow wood chip transfer means;
e) a wood chip dispenser for consistent delivery of said refined wood chips;
f) a wood chip pelleter;
g) a pellet cooling bin;
h) combined pellet transfer means with means for separating wood fines;
i) a means for separation of said wood fines and wood particles from air to be released into the atmosphere; and
j) a means for re-circulation of said wood fines, said wood particles and said airflow.

2. A wood pelleter production system of claim 1, where said infeed dryer deck has at least one endless bar chain drawing wood chips from under a wood chip pile.

3. A wood pelleter production system of claim 2, where said infeed dryer deck has a permeable floor outside of said receiving area, where said permeable floor allows air or heated air to flow up through said permeable floor, for drying said wood chips as said wood chips flow along said infeed dryer deck.

4. A wood pelleter production system of claim 3, where said permeable floor has an array of elongated inverted louvers, substantially perpendicular to said wood chip flow, for passage of said air or heated air, for drying of said wood chips as said wood chips are moving along said infeed dryer deck.

5. A wood pelleter production system of claim 2, where said infeed dryer deck has an adjustable shear gate directly adjacent to said wood chip receiving area.

6. A wood pelleter production system of claim 1, where said means to refine said wood chips is a hammer mill connected to said re-circulatory airflow.

7. A wood pelleter production system of claim 1, where said wood chip dispenser consists of a plurality of counter-rotating augers.

8. A wood pelleter production system of claim 7, where said wood chip dispenser has a means for visual monitoring of said wood chips above said counter-rotating augers.

9. A wood pelleter production system of claim 7, where said counter-rotating augers have separating elongating troughs that meet one another to create an elongated point.

10. A wood pelleter production system of claim 1, where said pellet cooling bin is connected to said re-circulatory airflow and where said pellet cooling bin consists of a hopper with a fractional rotating grated floor capable of allowing airflow through pellets when closed as well as open.

11. A wood pelleter production system of claim 10, where said rotating floor grates are a plurality of elongated L-shaped bars pivoting at one end.

12. A wood pelleter production system of claim 1, where said pellet transfer means is a vibratory conveyor with at least one screened floor section, where said screened floor section is connected to said re-circulatory airflow.

13. A wood pelleter production system of claim 1, where said means for separation of wood fines from air released into the atmosphere, is a bag house connected to said re-circulatory airflow for re-circulation of chip particles, fines and airflow.

14. A wood pelleter production system of claim 1, wherein the pelleter motor has a field temperature sensor for monitoring the field temperature for increasing amperage efficiency.

15. A combined wood chip conveyance and wood chip drying means, comprising: a wood chip receiving area and a wood chip infeed deck having a connecting wood chip dryer deck; said wood chip infeed deck and said wood chip dryer deck having at least one endless chain pair with spaced bars therebetween; said infeed deck is positioned on a floor of said wood chip receiving area, with a partition above said infeed deck and separating said dryer deck; an adjustable wood chip shear gate mounted on said partition, substantially centered over top of said wood chip infeed deck and said dryer deck, where said wood chip dryer deck is outside of said wood chip receiving area; where said wood chip drying deck has an array of elongated inverted louvers to allow air flow in one direction and chip transfer in a second direction, where said elongated inverted louvers are substantially perpendicular to said second direction; and a plenum for delivery of air or heated air directly under said wood chip dryer deck.

16. A combined wood chip conveyance and wood chip drying means, comprising: a wood chip receiving area and a wood chip infeed deck having a connecting wood chip dryer deck; said wood chip infeed deck and said wood chip dryer deck having at least one endless chain pair with spaced bars therebetween; said infeed deck is positioned on a floor of said wood chip receiving area, with a partition above said infeed deck and separating said dryer deck; an adjustable wood chip shear gate mounted on said partition, substantially centered over top of said wood chip infeed deck and said dryer deck, where said wood chip dryer deck is outside of said wood chip receiving area; where said wood chip drying deck has an array of elongated inverted louvers to allow air flow in one direction and chip transfer in a second direction, where said elongated inverted louvers are substantially perpendicular to said second direction; a plenum for delivery of a mix of heated air and flue gas directly under said wood chip dryer deck and through said louvers; and a plenum for above said wood chip dryer deck for controlled exit of said a mix of heated air and flue gas.

17. A combined wood chip conveyance and wood chip drying means of claim 15 where said mix of heated air and flue gas is done in a mixing chamber above a pellet burner, where said mixing chamber has adjustable doors to allow atmospheric air in to said mixing chamber.

18. A combined wood chip conveyance and wood chip drying means of claim 16 where said mixing chamber has a plurality of levels where said levels are separated by shelves.

19. A combined wood chip conveyance and wood chip drying means of claim 15 where said heated air and flue gas includes a spark detector with a spark diverter located before said plenum for delivery of a mix of heated air and flue gas to said infeed dryer deck.
